(19) United States
(12) Patent Application Publication
(10) Pub. No.: US 2026/0370082 A1
(43) Pub. Date: Nov. 19, 2026

(54) ELECTRICAL AND LIQUID FEEDTHROUGH SYSTEM FOR A COMPRESSOR

(71) Applicant: Tyco Fire & Security GmbH, Neuhausen am Rheinfall (CH)

(72) Inventors: Bryson Lee Sheaffer, Mechanicsburg, PA (US); Jordan Quinn Steiner, York, PA (US); Paul William Snell, York, PA (US)

(21) Appl. No.: 19/153,930

(22) PCT Filed: Feb. 7, 2024
(86) PCT No.: PCT/US2024/014798

§ 371 Date: Aug. 5, 2025

Related U.S. Application Data
(60) Provisional application No. 63/443,921, filed on Feb. 7, 2023.
(60) Provisional application No. 63/451,852, filed on Mar. 13, 2023.

(51) Int. Cl. H02K 5/22; F25B 31/02; H02K 5/10; H02K 11/21

(52) U.S. Cl. CPC H02K 5/225; F25B 31/026; H02K 5/10; H02K 11/21

(57) ABSTRACT

A heating, ventilation, air conditioning, and refrigeration (HVAC&R) system includes a motor housing of a compressor and a feedthrough connector coupled to the motor housing. The feedthrough connector includes a first passage and a second passage formed therethrough. The first passage is configured to receive a fluid conduit, and the second passage is configured to receive an electrical wire. The HVAC&R system also includes a bearing disposed within the motor housing. The bearing is configured to receive a pressurized fluid via the fluid conduit. Additionally, the HVAC&R system includes a sensor disposed within the motor housing. The electrical wire is configured to transmit electrical signals from the sensor and through the feedthrough connector.

### CROSS-REFERENCE TO RELATED APPLICATIONS

This application claims priority from and the benefit of U.S. Provisional Application No. 63/451,852, entitled “ELECTRICAL AND LIQUID FEEDTHROUGH FOR COMPRESSOR,” filed Mar. 13, 2023, and U.S. Provisional Application No. 63/443,921, entitled “BEARING SYSTEM FOR HVAC&R SYSTEM,” filed Feb. 7, 2023, each of which is hereby incorporated by reference in its entirety for all purposes.

### BACKGROUND

This section is intended to introduce the reader to various aspects of art that may be related to various aspects of the present disclosure, which are described below. This discussion is believed to be helpful in providing the reader with background information to facilitate a better understanding of the various aspects of the present disclosure. Accordingly, it should be understood that these statements are to be read in this light, and not as admissions of prior art.

Chiller systems, or vapor compression systems, utilize a working fluid (e.g., a refrigerant) that changes phases between vapor, liquid, and combinations thereof in response to exposure to different temperatures and pressures within components of the chiller system. The chiller system may place the working fluid in a heat exchange relationship with a conditioning fluid (e.g., water) and may deliver the conditioning fluid to conditioning equipment and/or a conditioned environment serviced by the chiller system. In such applications, the conditioning fluid may be directed through downstream equipment, such as air handlers, to condition other fluids, such as air in a building. The chiller system may include a compressor configured to pressurize the working fluid and circulate the working fluid through a working fluid circuit of the chiller system. In some applications, a shaft of the compressor may be driven in rotation by a motor in order to drive rotation of an impeller of the compressor that pressurizes the working fluid. Traditionally, the compressor includes bearings configured to facilitate rotation of the shaft. Unfortunately, existing bearings utilized with compressors may be complex, expensive, and/or may contribute to inefficiencies in operation of the chiller system.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

In one embodiment, a heating, ventilation, air conditioning, and refrigeration (HVAC&R) system includes a motor housing of a compressor and a feedthrough connector coupled to the motor housing. The feedthrough connector includes a first passage and a second passage formed therethrough. The first passage is configured to receive a fluid conduit, and the second passage is configured to receive an electrical wire. The HVAC&R system also includes a bearing disposed within the motor housing. The bearing is configured to receive a pressurized fluid via the fluid conduit. Additionally, the HVAC&R system includes a sensor disposed within the motor housing. The electrical wire is configured to transmit electrical signals from the sensor and through the feedthrough connector.

In another embodiment, a heating, ventilation, air conditioning, and refrigeration (HVAC&R) system includes a compressor having a rotor shaft disposed within a hermetic housing. The HVAC&R system also includes a feedthrough connector coupled to the hermetic housing. The feedthrough connector includes a first passage and a second passage formed therethrough. The HVAC&R system further includes a fluid conduit fluidly coupled to the first passage and an electrical wire extending through the second passage. Additionally, the HVAC&R system includes a bearing disposed about the rotor shaft. The bearing is configured to receive a pressurized fluid via the fluid conduit. Furthermore, the HVAC&R system includes a sensor disposed within the hermetic housing. The electrical wire is configured to transmit electrical signals between the sensor and an exterior of the hermetic housing via the feedthrough connector.

In another embodiment, a feedthrough system for a hermetic compressor includes a feedthrough body having a first passage and a second passage formed therethrough. The feedthrough system also includes a fluid conduit fluidly coupled to the first passage and configured to direct a pressurized fluid toward a bearing of the hermetic compressor. Additionally, the feedthrough system includes one or more electrical wires extending through the second passage and configured to transmit one or more electric currents through the feedthrough body. Furthermore, the feedthrough system includes a potting compound disposed within the second passage and configured to block fluid flow through the second passage.

### DRAWINGS

Various aspects of this disclosure may be better understood upon reading the following detailed description and upon reference to the drawings in which:

FIG. 1 is a perspective view of an embodiment of a building that may utilize a heating, ventilating, air conditioning, and refrigeration (HVAC&R) system in a commercial setting, in accordance with an aspect of the present disclosure;

FIG. 2 is a perspective view of an embodiment of a vapor compression system, in accordance with an aspect of the present disclosure;

FIG. 3 is a schematic of an embodiment of a vapor compression system, in accordance with an aspect of the present disclosure;

FIG. 4 is a schematic of an embodiment of a vapor compression system, in accordance with an aspect of the present disclosure;

FIG. 5 is a cross-sectional side view of an embodiment of a compressor of a vapor compression system, illustrating a bearing system of the compressor, in accordance with an aspect of the present disclosure;

FIG. 6 is a perspective view of an embodiment of a feedthrough connector for a bearing system of a compressor, in accordance with an aspect of the present disclosure;

FIG. 7 is a cross-sectional side view of an embodiment of a feedthrough connector for a bearing system of a compressor, in accordance with an aspect of the present disclosure;

FIG. 8 is a schematic of an embodiment of a compressor including a bearing system, in accordance with an aspect of the present disclosure; and

FIG. 9 is a schematic of an embodiment of a vapor compression system including a bearing system of a compressor, in accordance with an aspect of the present disclosure.

### DETAILED DESCRIPTION

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features.

As used herein, the terms “approximately,” “generally,” and “substantially,” and so forth, are intended to convey that the property value being described may be within a relatively small range of the property value, as those of ordinary skill would understand. For example, when a property value is described as being “approximately” equal to (or, for example, “substantially similar” to) a given value, this is intended to mean that the property value may be within +/−5%, within +/−4%, within +/−3%, within +/−2%, within +/−1%, or even closer, of the given value. Similarly, when a given feature is described as being “substantially parallel” to another feature, “generally perpendicular” to another feature, and so forth, this is intended to mean that the given feature is within +/−5%, within +/−4%, within +/−3%, within +/−2%, within +/−1%, or even closer, to having the described nature, such as being parallel to another feature, being perpendicular to another feature, and so forth. Further, it should be understood that mathematical terms, such as “planar,” “slope,” “perpendicular,” “parallel,” and so forth are intended to encompass features of surfaces or elements as understood to one of ordinary skill in the relevant art, and should not be rigidly interpreted as might be understood in the mathematical arts. For example, a “planar” surface is intended to encompass a surface that is machined, molded, or otherwise formed to be substantially flat or smooth (within related tolerances) using techniques and tools available to one of ordinary skill in the art. Similarly, a surface having a “slope” is intended to encompass a surface that is machined, molded, or otherwise formed to be oriented at an angle (e.g., incline) with respect to a point of reference using techniques and tools available to one of ordinary skill in the art.

Embodiments of the present disclosure relate to a heating, ventilation, air conditioning, and refrigeration (HVAC&R) system (e.g., a chiller) including a vapor compression system (e.g., vapor compression circuit) having a compressor. In operation, the compressor may pressurize a working fluid within the vapor compression system and direct the working fluid to a condenser (e.g., a first heat exchanger), which may cool and condense the working fluid via heat exchange with a cooling fluid. The condensed working fluid may be directed to an expansion device, which may reduce a pressure of the working fluid, further cooling the working fluid. From the expansion device, the cooled working fluid may be directed to an evaporator (e.g., a second heat exchanger), where the working fluid may be placed in a heat exchange relationship with a conditioning fluid to cool the conditioning fluid. The conditioning fluid may be circulated between the evaporator and a structure, such as a building, where the conditioning fluid is used to cool an air flow delivered to a conditioned space of the structure. In some embodiments, an air handling unit (AHU) of the HVAC&R system may receive the conditioning fluid from the chiller and utilize the conditioning fluid to cool the air flow delivered to the conditioned space. The conditioning fluid may then be returned to the evaporator to be cooled again.

In some embodiments, the compressor may include an impeller configured to rotate to enable pressurization of the working fluid and to direct the working fluid through the vapor compression system. For example, the impeller may be coupled to a shaft, and the shaft may be configured to rotate relative to a housing of the compressor to drive rotation of the impeller relative to the housing. Typically, the compressor includes one or more bearings configured to facilitate rotation of the shaft relative to the housing of the compressor. In particular, bearing systems described herein are configured to utilize a pressurized fluid, such as a portion of the working fluid (e.g., refrigerant) circulated through the vapor compression system, to support a load (e.g., a radial load) of the shaft of the compressor and lubricate rotation of the shaft within the housing of the compressor. To this end, the pressurized fluid may be supplied to the bearing systems within the housing of the compressor from components external to the housing of the compressor. Additionally, the bearing systems may be configured to transmit and/or receive electrical signals (e.g., sensor signals) to and/or from electrical systems (e.g., control systems) external to the housing of the compressor. In some embodiments, the compressor may be a hermetic compressor. That is, components within the housing of the compressor may be hermetically sealed from an environment external to the housing. Accordingly, feedthrough systems are desired to deliver pressurized fluid to the bearing systems within the housing and to enable transmission of electrical signals into and out of the housing of the compressor while maintaining hermeticity (e.g., a sealed configuration) of the compressor.

Accordingly, present embodiments are directed to a feedthrough connector (e.g., feedthrough system, feedthrough attachment, feedthrough adapter feedthrough coupling, feedthrough assembly, hermetic feedthrough) that includes a fluid passage and an electrical passage configured to enable delivery of fluid and electrical signals through a housing (e.g., hermetic housing) of a compressor. In particular, the feedthrough connector is configured to convey a flow of fluid and a flow of electric current (e.g., electrical signals) between an environment external to the housing and a bearing system disposed within the housing. For example, the feedthrough connector may be coupled to (e.g., disposed within) an opening of the housing, and the feedthrough connector may enable flow of fluid and electrical signals to pass through the opening via the feedthrough connector. A feedthrough body of the feedthrough connector may be secured to the housing within the opening to hermetically seal the opening while providing passages (e.g., a first passage and a second passage) through which fluid flow and electrical signals may pass through the opening. In some embodiments, the passages may be through-holes machined through the feedthrough body, and a fluid conduit and an electrical conduit (e.g., wire, cable, etc.) may extend through the opening via a corresponding one of the passages (e.g., through-holes). A respective interface between each of the conduits and its corresponding passage or through-hole may be sealed (e.g., airtight, fluidly sealed) in order to maintain a hermetic seal of the compressor at the feedthrough connector and opening of the housing. For example, one or more O-rings may be disposed around the fluid conduit within a first passage of the feedthrough body. As another example, the electrical conduit may be potted (e.g., packed, wedged, restrained) within a second passage of the feedthrough body using a potting compound, such as resin, thermoplastic, silicone, or other suitable material. In this way, flow of fluid and flow of electrical signals may pass into and out of the housing via the feedthrough connector while maintaining the hermeticity of the compressor.

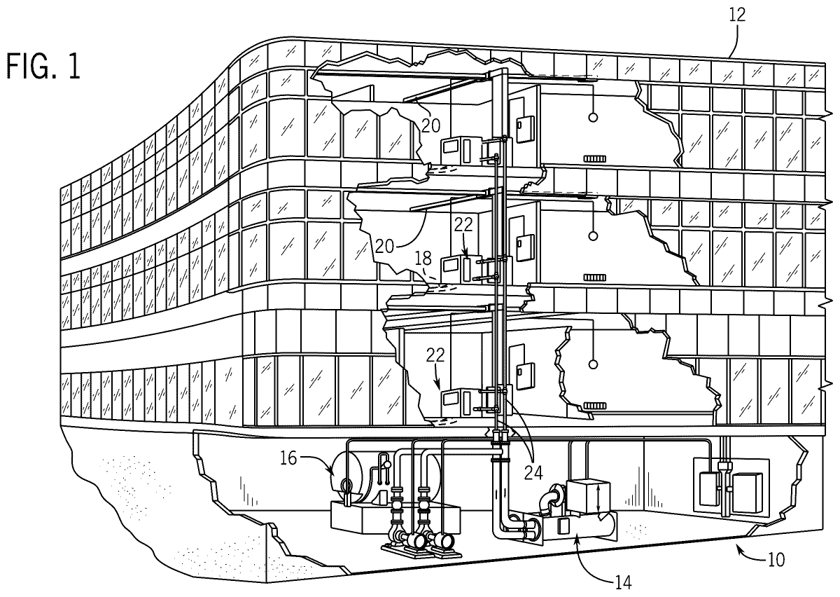

Turning now to the drawings, FIG. 1 is a perspective view of an embodiment of a heating, ventilating, air conditioning, and refrigeration (HVAC&R) system 10 in a building 12 for a typical commercial setting. The HVAC&R system may include a boiler 16 to supply warm liquid to heat the building 12 and a vapor compression system 14 to supply chilled liquid to cool the building 12. The vapor compression system 14, sometimes referred to as a chiller, may circulate a working fluid (e.g., refrigerant) that is cooled by a cooling fluid (e.g., liquid such as water) in a condenser of the vapor compression system 14, and that is heated by a conditioning fluid (e.g., liquid, such as water) in an evaporator of the vapor compression system 14. The cooling fluid may be provided by a cooling tower which cools the cooling fluid via, for example, ambient air. The conditioning fluid, cooled by the working fluid as noted above, may be utilized to cool an air flow provided to conditioned spaces of the building 12.

The HVAC&R system 10 may also include an air distribution system which circulates air through the building 12. The air distribution system can also include an air return duct 18, an air supply duct 20, and/or an air handler 22. In some embodiments, the air handler 22 may include a heat exchanger that is connected to the boiler 16 and the vapor compression system 14 by conduits 24. The heat exchanger in the air handler 22 may receive either heated liquid from the boiler 16 or the conditioning fluid (e.g., chilled liquid such as water) from the vapor compression system 14, depending on the mode of operation of the HVAC&R system 10. The HVAC&R system 10 is shown with a separate air handler on each floor of building 12, but in other embodiments, the HVAC&R system 10 may include air handlers 22 and/or other components that may be shared between or among floors.

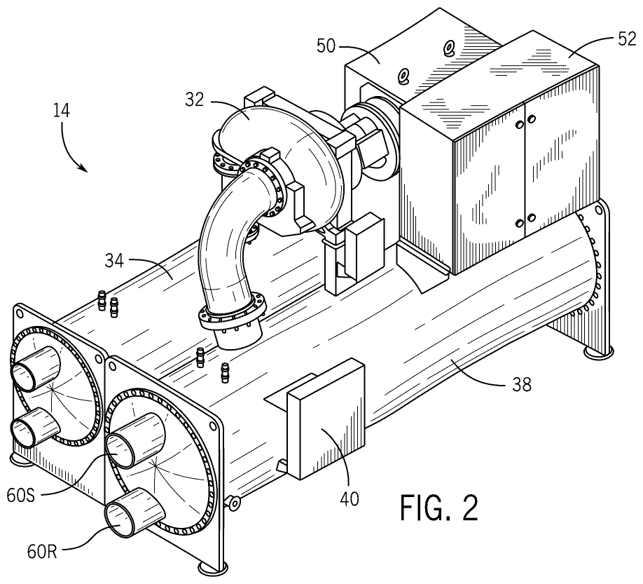

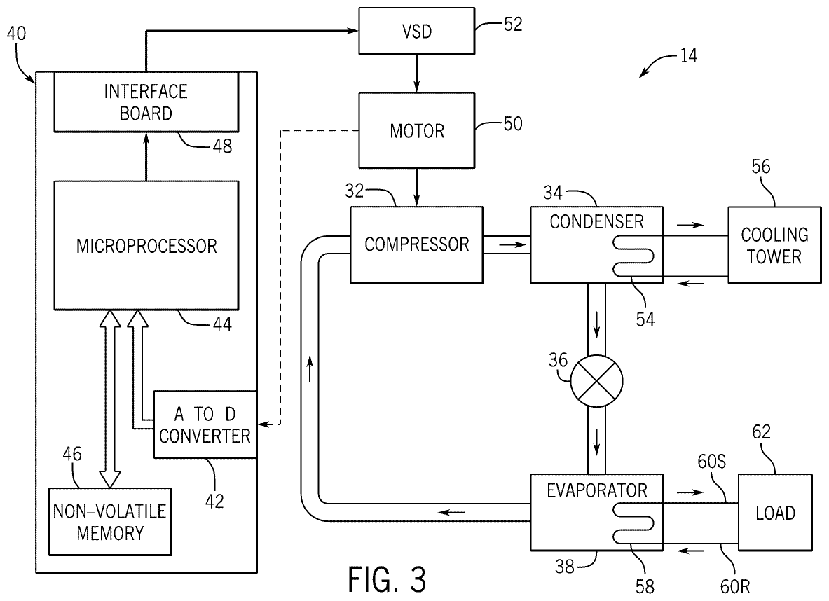

FIGS. 2 and 3 illustrate embodiments of the vapor compression system 14, or chiller, which can be used in the HVAC&R system 10. The vapor compression system 14 may circulate a working fluid through a circuit (e.g., working fluid circuit, refrigerant loop) starting with a compressor 32, such as a centrifugal compressor. The circuit may also include a condenser 34, an expansion valve(s) or device(s) 36, and an evaporator 38. The vapor compression system 14 may further include a control panel 40 that has an analog to digital (A/D) converter 42, a microprocessor 44, a non-volatile memory 46, and/or an interface board 48.

Some examples of fluids that may be used as working fluids in the vapor compression system 14 are hydrofluorocarbon (HFC) based working fluids (e.g., refrigerants), for example, R-410A, R-407, R-134a, hydrofluoro olefin (HFO), “natural” refrigerants like ammonia (NH₃), R-717, carbon dioxide (CO₂), R-744, or hydrocarbon-based working fluids, water vapor, or any other suitable working fluid. Other possible refrigerants include R-123, R-514A, R-1224yd, R-1233zd, R-134a, R-1228ze, R-1228yf, R-1311, R-32, and R-410A. In some embodiments, the vapor compression system 14 may be configured to efficiently utilize working fluids having a normal boiling point of about 19 degrees Celsius (66 degrees Fahrenheit) at one atmosphere of pressure, also referred to as low pressure working fluids, versus a medium pressure working fluid, such as R-134a. As used herein, “normal boiling point” may refer to a boiling point temperature measured at one atmosphere of pressure.

In some embodiments, the vapor compression system 14 may use one or more of a variable speed drive (VSDs) 52, a motor 50, the compressor 32, the condenser 34, the expansion valve or device 36, and/or the evaporator 38. The motor 50 may drive the compressor 32 during a normal operating mode and may be powered by a variable speed drive (VSD) 52. The VSD 52 receives alternating current (AC) power during the normal operating mode, where the AC power includes a particular fixed line voltage and fixed line frequency from an AC power source, and provides power having a variable voltage and frequency to the motor 50. In other embodiments, the motor 50 may be powered directly from an AC or direct current (DC) power source. The motor 50 may include any type of electric motor that can be powered by a VSD or directly from an AC or DC power source, such as a switched reluctance motor, an induction motor, an electronically commutated permanent magnet motor, or another suitable motor.

The compressor 32 compresses a working fluid vapor and delivers the vapor to the condenser 34 through a discharge passage. In some embodiments, the compressor 32 may be a centrifugal compressor. The working fluid vapor delivered by the compressor 32 to the condenser 34 may transfer heat to a cooling fluid (e.g., water or air) in the condenser 34. The working fluid vapor may condense to a working fluid liquid in the condenser 34 as a result of thermal heat transfer with the cooling fluid. The liquid working fluid from the condenser 34 may flow through the expansion device 36 to the evaporator 38. In the illustrated embodiment of FIG. 3, the condenser 34 is water cooled and includes a tube bundle 54 connected to a cooling tower 56, which supplies the cooling fluid to the condenser 34.

The liquid working fluid delivered to the evaporator 38 may absorb heat from a conditioning fluid that is subsequently routed to a load 62 (e.g., the building 12 of FIG. 1). For example, the conditioning fluid may be cooled by the working fluid in the evaporator 38, and then may be utilized in the building 12 of FIG. 1 to condition an air flow provided to condition a space in the building 12. The liquid working fluid in the evaporator 38 may undergo a phase change from the liquid working fluid to a working fluid vapor. As shown in the illustrated embodiment of FIG. 3, the evaporator 38 may include a tube bundle 58 having a supply line 60S and a return line 60R connected to the cooling load 62. The conditioning fluid of the evaporator 38 (e.g., water, ethylene glycol, calcium chloride brine, sodium chloride brine, or any other suitable fluid) enters the evaporator 38 via return line 60R and exits the evaporator 38 via supply line 60S. The evaporator 38 may reduce the temperature of the conditioning fluid in the tube bundle 58 via thermal heat transfer with the working fluid. The tube bundle 58 in the evaporator 38 can include a plurality of tubes and/or a plurality of tube bundles. In any case, the vapor working fluid exits the evaporator 38 and returns to the compressor 32 by a suction line to complete the cycle.

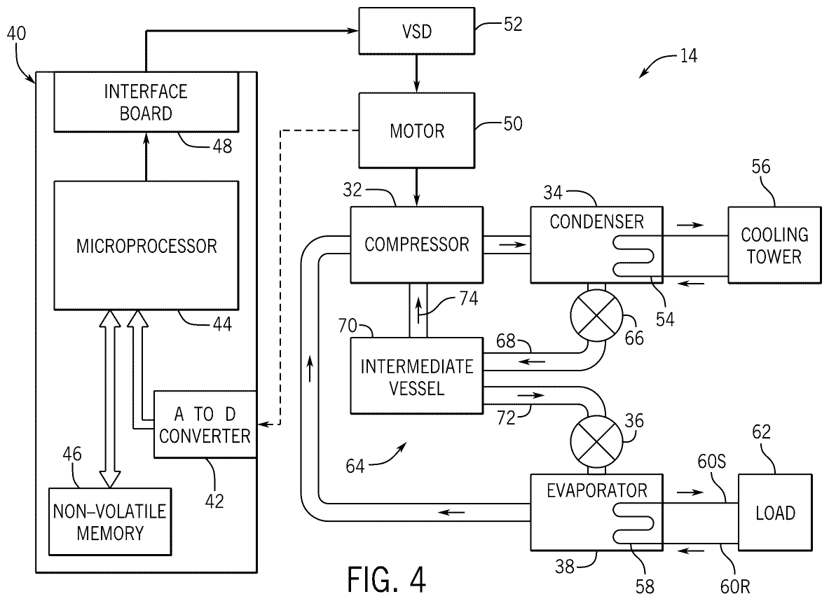

FIG. 4 is a schematic of an embodiment of the vapor compression system 14 with an intermediate circuit 64 incorporated between the condenser 34 and the expansion device 36. The intermediate circuit 64 may have an inlet line 68 that is directly fluidly connected to the condenser 34. In other embodiments, the inlet line 68 may be indirectly fluidly coupled to the condenser 34. As shown in the illustrated embodiment of FIG. 4, the inlet line 68 includes a first expansion device 66 positioned upstream of an intermediate vessel 70. In some embodiments, the intermediate vessel 70 may be a flash tank (e.g., a flash intercooler). In other embodiments, the intermediate vessel 70 may be configured as a heat exchanger or a “surface economizer.” In the illustrated embodiment of FIG. 4, the intermediate vessel 70 is used as a flash tank, and the first expansion device 66 is configured to lower the pressure of (e.g., expand) the liquid working fluid received from the condenser 34. During the expansion process, a portion of the liquid working fluid may vaporize, and thus, the intermediate vessel 70 may be used to separate the vapor working fluid from the liquid working fluid received from the first expansion device 66. Additionally, the intermediate vessel 70 may provide for further expansion of the liquid working fluid due to a pressure drop experienced by the liquid working fluid when entering the intermediate vessel 70 (e.g., due to a rapid increase in volume experienced when entering the intermediate vessel 70). The vapor working fluid in the intermediate vessel 70 may be drawn by the compressor 32 through a suction line 74 of the compressor 32. In other embodiments, the vapor working fluid in the intermediate vessel 70 may be drawn to an intermediate stage of the compressor 32 (e.g., not the suction stage). The liquid working fluid that collects in the intermediate vessel 70 may be at a lower enthalpy than the liquid working fluid exiting the condenser 34 due to expansion of the working fluid at the expansion device 66 and/or in the intermediate vessel 70. The liquid working fluid from intermediate vessel 70 may then flow through line 72 and through a second expansion device 36 to the evaporator 38.

In accordance with present embodiments, the compressor 32 may be a centrifugal compressor (e.g., a hermetic compressor) having a levitated rotor or shaft. To this end, the vapor compression system 14 includes a bearing system with one or more bearings configured to support a load of the shaft of the compressor 32. The bearing system is configured to direct a pressurized fluid (e.g., liquid) through the bearings, and the bearings are configured to discharge the fluid toward and against the shaft in order to enable levitation of the shaft within the compressor 32. Specifically, the bearings include one or more porous bearing elements configured to receive the pressurized fluid and direct the pressurized fluid toward the shaft within a housing (e.g., hermetic housing) of the compressor 32. For example, the bearings may cause the pressurized fluid to contact (e.g., impinge against) the shaft with sufficient force to suspend the shaft over or in the pressurized fluid. Additionally, the pressurized fluid may vaporize (e.g., flash) and/or expand upon being discharged from the bearings due to a change in pressure. As a result, the pressurized fluid may separate the shaft from contacting other surfaces (e.g., the bearings) of the compressor 32 and thus provide a low-friction environment in which the shaft may rotate. For example, the shaft may be suspended in and/or by the pressurized fluid. In this way, the bearing system may support a load on the shaft and enable rotation of the shaft within the housing of the compressor 32 during operation of the vapor compression system 14. As discussed herein, the pressurized fluid may be a working fluid (e.g., refrigerant) circulated through the vapor compression system 14. Thus, the vapor compression system 14 may not utilize a dedicated lubricant, such as oil, to support and enable rotation of the shaft of the compressor 32. Further, the bearing system may be incorporated with the vapor compression system 14 at reduced costs, as compared to other existing bearing system designs.

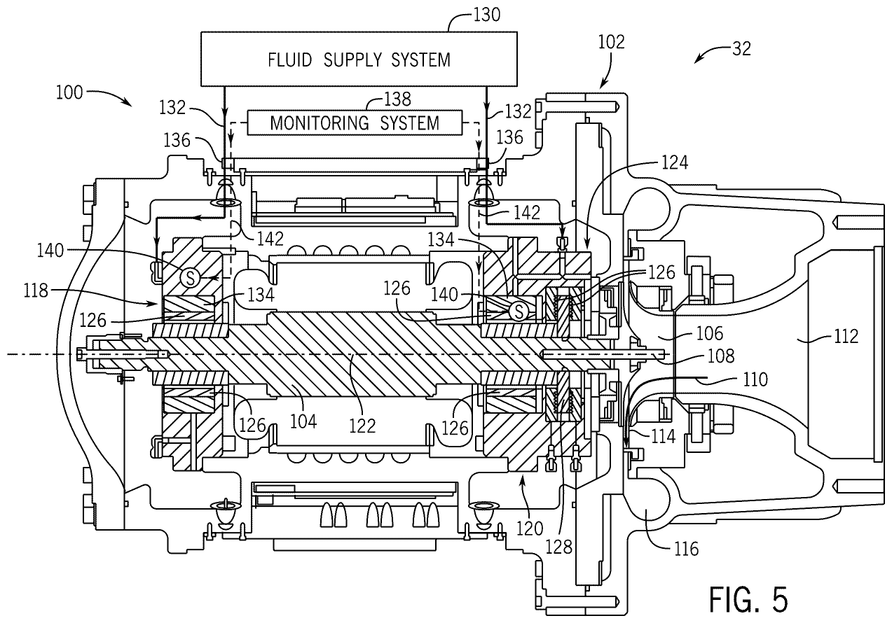

With the foregoing in mind, FIG. 5 is a cross-sectional side view of an embodiment of the compressor 32 including a bearing system 100, in accordance with aspects of the present disclosure. The compressor 32 may include a housing 102 (e.g., hermetic housing, motor housing, compressor housing) and a shaft 104 extending through the housing 102. The compressor 32 may also include an impeller 106 coupled to the shaft 104, such as via a fastener 108. During operation of the compressor 32, the shaft 104 may rotate (e.g., via operation of the motor 50) and cause rotation of the impeller 106. Rotation of the impeller 106 may drive a working fluid (e.g., refrigerant) to flow through a working fluid flow path 110 (e.g., from the evaporator 38, from the intermediate vessel 70) to draw the working fluid into the housing 102 via a suction inlet 112 and toward the impeller 106. The impeller 106 may impart mechanical energy onto the working fluid and discharge the working fluid to a diffuser passage 114 of the compressor 32. The working fluid may be directed from the diffuser passage 114 to a volute 116 of the compressor 32 and from the volute 116 to a condenser (e.g., the condenser 34) for heat exchange with a fluid, such as a cooling fluid.

In the illustrated embodiment, the compressor 32 (e.g., bearing system 100) includes a first bearing 118 (e.g., a radial bearing, bearing assembly, porous bearing) and a second bearing 120 (e.g., a radial bearing, bearing assembly, porous bearing) configured to control and/or adjust a position (e.g., radial position) of the shaft 104 relative to an axis 122 (e.g., rotational axis, central axis) of the shaft 104. For example, the first bearing 118 and the second bearing 120 may be configured to support a load (e.g., radial load) of the shaft 104, such that the shaft 104 levitates within the first bearing 118 and the second bearing 120. The first bearing 118 and the second bearing 120 may also be configured to block movement (e.g., bending, radial movement, eccentric rotation) of the shaft 104 crosswise to the axis 122. The compressor 32 (e.g., bearing system 100) further includes a third bearing 124 (e.g., thrust bearing, axial bearing, bearing assembly, porous bearing) configured to control and/or adjust a position (e.g., axial position) of the shaft 104 along the axis 122. For example, the third bearing 124 may be configured to block or limit movement (e.g., translation) of the shaft 104 along the axis 122.

As mentioned above, the bearing system 100 is configured to direct a pressurized fluid to bearings of the bearing system 100, such as the first bearing 118, the second bearing 120, and/or the third bearing 124. The pressurized fluid may be the same working fluid (e.g., refrigerant) circulated through the vapor compression system 14 (e.g., working fluid circuit) having the compressor 32. However, it should be appreciated that the pressurized fluid may be any suitable fluid, such as a refrigerant, a condensable vapor, or other fluid. In some embodiments, the first bearing 118, the second bearing 120, and/or the third bearing 124 each include one or more porous elements 126 configured to direct the pressurized fluid therethrough. For example, the one or more porous elements 126 of the first bearing 118 and the second bearing 120 may be configured to received pressurized fluid and direct the pressurized fluid towards the shaft 104 to establish a high-pressure fluid film (e.g., vapor film) about the shaft 104 between the first bearing 118 and the second bearing 120 and the shaft 104. In this way, the pressurized fluid may cause the shaft 104 to levitate from the first bearing 118 and the second bearing 120, thereby enabling desired rotation of the shaft 104 about the axis 122. The one or more porous elements 126 of the third bearing 124 may receive pressurized fluid and direct the pressurized fluid towards a collar 128 (e.g., thrust collar) of the third bearing 124. In this way, the pressurized fluid may apply a force to the collar 128 and enable adjustable positioning of the shaft 104 along the axis 122.

The bearing system 100 includes a fluid supply system 130 configured to supply pressurized fluid to the bearings (e.g., first bearing 118, second bearing 120, and/or third bearing 124) of the bearing system 100. For example, the fluid supply system 130 may direct the pressurized fluid through the housing 102 of the compressor 32 via one or more fluid conduits 132 (e.g., pipes, tubes, etc.). In some embodiments, the fluid conduits 132 may fluidly couple the fluid supply system 130 to one or more bearing housings 134 (e.g., casings) of the first bearing 118, the second bearing 120, and the third bearing 124. Each fluid conduit 132 may extend through a feedthrough connector 136 (e.g., hermetic feedthrough, feedthrough system) coupled to the housing 102. For example, the housing 102 may include multiple feedthrough connectors 136 coupled thereto, each fluid conduit 132 may extend through one of the feedthrough connectors 136. In some embodiments, multiple fluid conduits 132 may extend through one feedthrough connector 136.

The feedthrough connector 136 provides a passage for the fluid conduit 132 to extend into the housing 102. In some embodiments, the housing 102 includes an opening for one or more of the fluid conduits 132, and the feedthrough connector 136 is positioned within the opening and/or coupled to the housing 102 to seal the opening of the housing 102. In this way, the pressurized fluid may flow from the fluid supply system 130, through the fluid conduits 132, through the feedthrough connectors 136, into the housing 102, and to the bearing housings 134 of the first bearing 118, the second bearing 120, and/or the third bearing 124. The illustrated embodiment of the housing 102 includes two feedthrough connectors 136. One feedthrough connector 136 accommodates one fluid conduit 132 extending therethrough or therein, which supplies the pressurized fluid to the first bearing 118, and the other feedthrough connector 136 accommodates another fluid conduit 132 that supplies the pressurized fluid to the second bearing 120 and the third bearing 124. That is, the compressor 32 includes one feedthrough connector 136 for one or more bearings at a first end of the shaft 104 and another feedthrough connector 136 for one or more bearings at a second end, opposite the first end, of the shaft 104. In some embodiments, a single feedthrough connector 136 may accommodate the fluid conduits 132 and/or electrical lines for some or all of the bearings of the bearing system 100. In other embodiments, one fluid conduit 132 may extend from the fluid supply system 130 to the feedthrough connector 136, another fluid conduit 132 may extend from the feedthrough connector 136 to one of the bearings within the housing 102, and the feedthrough connector 136 may fluidly couple the two fluid conduits 132 (e.g., via a passage formed within the feedthrough connector 136).

In some embodiments, the fluid conduits 132 may include a fluid supply conduit and a fluid drain conduit. The pressurized fluid may enter the housing 102 via the fluid supply conduit, flow through the bearing housings 134, and exit the housing 102 via the fluid drain conduit. In other words, the feedthrough connector 136 may accommodate one fluid conduit 132 (e.g., first fluid conduit, fluid supply conduit) to direct the pressurized fluid into the housing 102 (e.g., to the bearings), and the feedthrough connector 136 may also accommodate another fluid conduit 132 (e.g., second fluid conduit, fluid drain conduit) to direct the fluid out of the housing 102. Alternatively, separate feedthrough connectors 136 may be incorporated for separate fluid conduits 132 (e.g., fluid supply conduits and fluid drain conduits). In any case, the fluid drain conduits may direct pressurized or depressurized fluid to a liquid conduit portion, a vapor conduit portion, or other conduit of a working fluid circuit (e.g., of the vapor compression system 14). In this way, the fluid utilized by the bearing system 100 to lubricate the bearings may also be used as a working fluid in the working fluid circuit.

In the illustrated embodiment, one bearing housing 134 is associated with the first bearing 118, and another bearing housing 134 is associated with the second bearing 120. An additional bearing housing 134 may be utilized with the third bearing 124. In other embodiments, the second bearing 120 and the third bearing 124 may be packaged together in a common bearing housing 134. The pressurized fluid may be directed through the bearing housings 134 to the corresponding porous elements 126 (e.g., bearing elements) retained within each bearing housing 134. The fluid supply system 130 is described in further detail below. It should be appreciated that the compressor 32 may include any suitable number or type (e.g., radial, axial) of bearings incorporating the present techniques, and the bearings may be positioned at any suitable location within the housing 102 of the compressor 32.

The bearing system 100 also includes a monitoring system 138 (e.g., controller, control system, control device) configured to monitor operating parameters of the bearing system 100. For example, the monitoring system 138 may include a controller, processing circuitry, and/or a memory, as described in further detail below. The monitoring system 138 may receive sensor data or feedback from one or more sensors 140 (e.g., bearing sensors, temperature sensors, pressure sensors) disposed within the housing 102. The one or more sensors 140 may monitor one or more operating parameters of the bearing system 100 and/or the compressor 32, such as a bearing temperature, a fluid temperature, a fluid pressure, a fluid flow rate, a speed of the shaft 104, a fluid force, a position of the shaft 104, a position of a bearing, and/or any other suitable operating parameter of the bearing system 100 and/or the compressor 32. In some embodiments, the monitoring system 138 may be integrated with a component of the control panel 40 or another controller of the bearing system 100 or vapor compression system 14.

As shown, the monitoring system 138 may be positioned external to the housing 102. To this end, the bearing system 100 includes electrical lines 142 (e.g., electrical conduits, wires, cables, etc.) configured to carry (e.g., transmit) electrical signals (e.g., sensor data, control signals, power, etc.) between the monitoring system 138 and the sensors 140. Thus, the electrical lines 142 extend from the monitoring system 138, through the housing 102, and to the sensors 140. In accordance with present techniques, the electrical lines 142 may extend into the housing 102 via the one or more feedthrough connectors 136. For example, one of the electrical lines 142 may be a cable, wire, or set of wires extending through a passage (e.g., a through-hole, an aperture) formed within a body of the feedthrough connector 136. In some embodiments, the feedthrough connector 136 may include one or more terminals configured to electrically couple an external segment (e.g., first segment) of the electrical line 142 (e.g., external to the housing 102) to an internal segment (e.g., second segment) of the electrical line 142 (e.g., within the housing 102). For example, the external segment of the electrical line 142 may be a first cable, wire, or set of wires connected to the monitoring system 138 and terminating at the terminal of the feedthrough connector 136, and the internal segment of the electrical line 142 may be a second cable, wire, or set of wires extending from one or more of the sensors 140 and terminating at the terminal of the feedthrough connector 136. In any case, the feedthrough connector 136 may include multiple (e.g., 2, 3, 5, 10) passages through which one or more electrical lines 142 and fluid conduits 132 may extend.

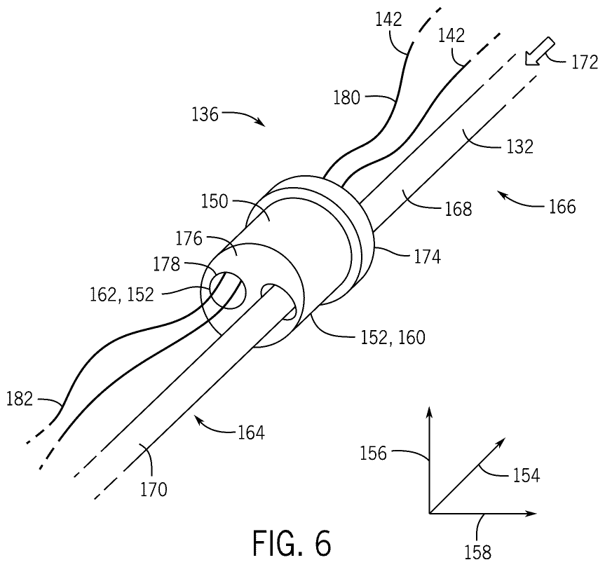

FIG. 6 is a perspective view of an embodiment of the feedthrough connector 136, illustrating the fluid conduit 132 and electrical lines 142 extending through the feedthrough connector 136. The feedthrough connector 136 (e.g., feedthrough system) includes a feedthrough body 150 (e.g., puck, cylindrical body) configured to couple to the housing 102 of the compressor 32. For example, the feedthrough body 150 may be inserted in an axial direction 154 into an opening of the housing 102. As mentioned above, the feedthrough connector 136 may be positioned within the opening and mounted or secured to the housing 102 in order to provide sealing interface between an interior of the housing 102 from an external environment surrounding the housing 102. For example, the housing 102 may extend in a radial direction 156 and a lateral direction 158, and the feedthrough body 150 may extend into the housing 102 (e.g., via the opening in the housing 102) in the axial direction 154 to align with the housing 102 along the radial direction 156 and/or the lateral direction 158.

The feedthrough body 150 may include a plurality of passages 152 (e.g., ports, holes, channels, apertures) extending through the feedthrough body 150, such as in the axial direction 154. In the illustrated embodiment, the passages 152 include a first passage 160 configured to receive the fluid conduit 132 and a second passage 162 configured to receive one or more electrical lines 142. In some embodiments, the first passage 160 may be configured to fluidly couple multiple fluid conduits 132, such as one fluid conduit 132 extending into the housing 102 and another fluid conduit 132 extending external to the housing 102. The first passage 160 and the second passage 162 may be fluidly and/or electrically isolated from one another. In other embodiments, the feedthrough connector 136 may include more passages (e.g., 3, 4, 10) to accommodate additional fluid conduits 132 (e.g., a second fluid conduit, a third fluid conduit, and so forth) and/or additional electrical lines 142 (e.g., a third electrical line). The feedthrough connector 136 may include separate passages 152 for separate electrical lines 142. In some embodiments, multiple electrical lines 142 may extend through the same passage 152 (e.g., the second passage 162).

As discussed above, the compressor 32 may be a hermetic compressor (e.g., a centrifugal compressor). For example, the housing 102 may maintain a high pressure within an interior 164 of the housing 102 (e.g., a first side of the feedthrough body 150) relative to lower pressure (e.g., atmospheric pressure) at an exterior 166 of the housing 102 (e.g., a second side of the feedthrough body 150). Therefore, the feedthrough connector 136 is configured to create a seal (e.g., airtight seal, fluid seal) across the passages 152 and around the fluid conduit 132 and the electrical lines 142.

In some embodiments, the fluid conduit 132 may have a rigid portion 168 and a flexible portion 170. The rigid portion 168 may be a pipe, tube, or other component configured to transport a flow of pressurized fluid 172 from the fluid supply system 130 to the feedthrough body 150. The rigid portion 168 may enter and/or fluidly couple to the first passage 160 at a first end 174 (e.g., externally-facing end, external side) of the feedthrough body 150. In other words, the rigid portion 168 may be securely coupled to the first passage 160 at the first end 174. In this way, the pressurized fluid may flow through the rigid portion 168 and into the first passage 160. The flexible portion 170 may be a tube or other flexible conduit configured to transport the flow of pressurized fluid 172 from the feedthrough body 150 to one or more of the bearing housings 134. As such, the flexible portion 170 may be coupled to the first passage 160 at a second end 176 (e.g., internally-facing end, interior side) of the feedthrough body 150. In this way, the pressurized fluid 172 may flow from the first passage 160, into the flexible portion 170, and out of the first passage 160. Alternatively, the flexible portion 170 may be coupled (e.g., directly coupled) to the rigid portion 168 such that the pressurized fluid 172 may flow directly between the rigid portion 168 and the flexible portion 170. In any case, the feedthrough connector 136 may join (e.g., fluidly couple) two portions of the fluid conduit 132 to transport the pressurized fluid 172 between the exterior 166 of the housing 102 and the interior 164 of the housing 102.

In some embodiments, the flexible portion 170 may include multiple tubes configured to split (e.g., divide, partition) the flow of pressurized fluid 172 in different flow directions as the pressurized fluid 172 exits the feedthrough connector 136. In this way, the flexible portion 170 may direct the pressurized fluid 172 to different locations (e.g., different bearings) within the housing 102.

The electrical lines 142 may extend through the feedthrough body 150 via the second passage 162. The second passage 162 may be a through-hole formed through the feedthrough body 150. In some embodiments, the electrical lines 142 may extend continuously through the feedthrough body 150 via the second passage 162 from the exterior 166 of the housing 102 to the interior 164 of the housing 102. A potting compound 178 (e.g., filler material, sealing material, epoxy, resin, silicone, cork, thermoplastic, another suitable polymer) may be disposed within the second passage 162 to hermetically seal a space within the second passage 162 between the electrical lines 142 and walls (e.g., internal walls) of the feedthrough body 150 defining the second passage 162. That is, the electrical lines 142 may be firmly encapsulated within the potting compound 178 and within the second passage 162. In this way, the potting compound 178 may block any undesired flow of fluid or matter (e.g., air or working fluid) through the second passage 162. Indeed, the potting compound 178 may define a pressure barrier between the exterior 166 of the housing 102 and the interior 164 of the housing 102. In some embodiments, the potting compound 178 may electrically isolate multiple electrical lines 142 extending through the second passage 162 form one another.

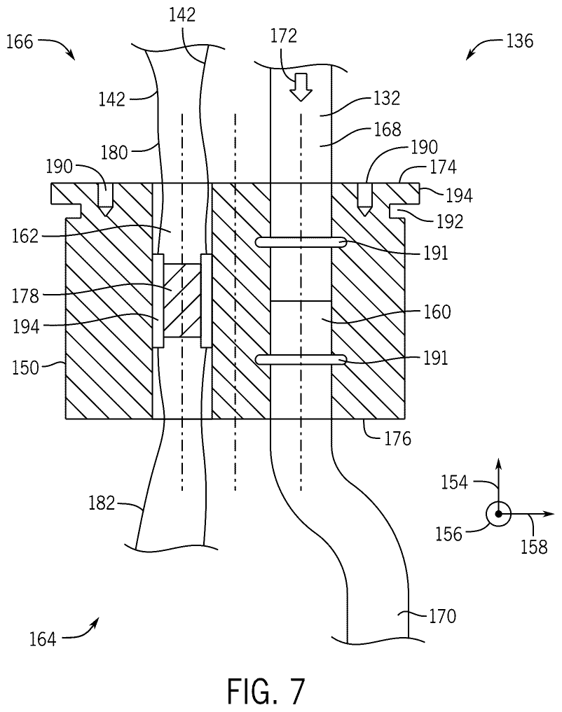

In some embodiments, each electrical line 142 may include an external segment 180 connected to the monitoring system 138 and an internal segment 182 connected to one or more of the sensors 140. The second passage 162 may include an electrical terminal (e.g., electrical terminal 194 shown in FIG. 7) to which one end of the external segment 180 is electrically coupled (e.g., plugged, crimped, soldered, etc.) and to which one end of the internal segment 182 is electrically coupled. The electrical terminal may be interposed (e.g., electrically coupled) between the external segment 180 and the internal segment 182 and thereby conduct electric current (e.g., signals) therebetween. In this way, the electrical terminal may removably couple the external segment 180 and the internal segment 182. The electrical connection between the monitoring system 138 and the sensors 140 may be connected and disconnected by connecting and disconnecting the external segment 180 and/or the internal segment 182 from the electrical terminal. However, in other embodiments, the external segment 180 may directly, electrically contact the internal segment 182 (e.g., as a single wire) without a terminal disposed therebetween.

FIG. 7 is a cross-sectional view of an embodiment of the feedthrough connector 136. As discussed above, the feedthrough connector 136 includes the feedthrough body 150 through which the first passage 160 and the second passage 162 may extend along the axial direction 154. The fluid conduit 132, which may include the rigid portion 168 and the flexible portion 170, extends through the first passage 160, as shown. Electrical lines 142 extend through the second passage 162. In the illustrated embodiment, each electrical line 142 includes a corresponding external segment 180 and a corresponding internal segment 182. The first end 174 of the feedthrough body 150 may include one or more tapped holes 190 (e.g., mounting points, mounting features, mounting recesses) to enable coupling of the feedthrough connector 136 to the housing 102. For example, screws may secure a plate to the feedthrough connector 136 via the tapped holes 190, and the plate may be secured to the housing 102.

To block flow of fluid (e.g., air or refrigerant) through the feedthrough connector 136, one or more O-rings 191 (e.g., gaskets) may be disposed between one or more walls (e.g., internal walls) of the feedthrough body 150 defining the first passage 160 and one or more walls (e.g., outer surface) of the fluid conduit 132. In some embodiments, the O-rings 191 may be positioned in grooves formed within the feedthrough body 150 along the first passage 160. In this way, flow of fluid through the first passage 160 between the feedthrough body 150 and the fluid conduit 132 (e.g., external to the fluid conduit 132) may be blocked. Additionally, the feedthrough body 150 may include a groove 192 formed within an outer surface of the feedthrough body 150 adjacent flange 194 extending outward from the feedthrough body 150 (e.g., along lateral direction 158). The O-ring 191 or other gasket may be positioned within the groove 192 to act as a contact interface and/or sealing interface between the feedthrough connector 136 and the housing 102 in an installed configuration of the feedthrough connector 136. That is, the O-ring 191 may be captured between the flange 194 and the housing 102, which may block flow of fluid between the feedthrough connector 136 and the housing 102 (e.g., between the exterior 166 of the housing 102 and the interior 164 of the housing 102).

In the illustrated embodiment, the feedthrough connector 136 also includes one or more electrical terminals 194 positioned within the second passage 162. Each electrical terminal 194 is configured to electrically couple the respective external segment 180 and the respective internal segment 182 of one of the electrical lines 142. As shown, each external segment 180 and each internal segment 182 terminates at one of the electrical terminals 194. Thus, the electrical terminal 194 may conduct electric current and/or signals between the segments 180, 182 of the corresponding electrical line 142. The electrical terminal 194 may include ports (e.g., connectors) configured to receive corresponding ends of the segments 180, 182. In some embodiments, the segments 180, 182 may be crimped or spliced at the electrical terminal 194. In any case, the electrical terminal 194 provides continuity in the respective segments 180, 182 of the electrical lines 142 when connected and breaks the continuity when disconnected. The potting compound 178 may partially or entirely encase (e.g., encapsulate) any or all of the electrical terminal 194, the external segment 180, and/or the internal segment 182.

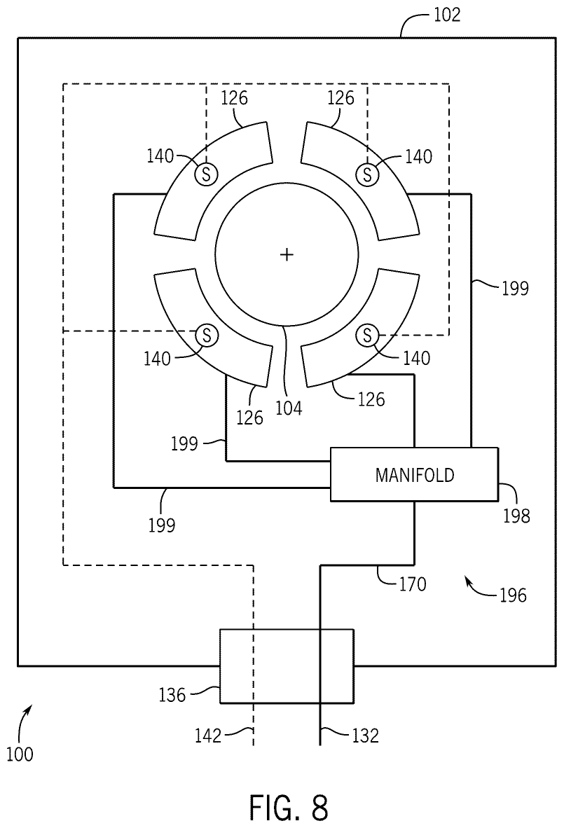

FIG. 8 is a schematic of portion of an embodiment of the compressor 32 and the bearing system 100, illustrating flow of pressurized fluid 172 within the housing 102 (e.g., from the fluid supply system 130) and flow of electrical signals within the housing 102. In the illustrated embodiment, a bearing assembly 196 (e.g., the first bearing 118, the second bearing 120) is disposed within the housing 102 about the shaft 104 and includes the porous elements 126 configured to direct the pressurized fluid through the porous elements 126 and toward the shaft 104. However, in other embodiments, the bearing assembly 196 may additionally or alternatively include a thrust bearing assembly. The fluid conduit 132 is configured to direct the pressurized fluid 172 into the housing 102 via the feedthrough connector 136 and toward a manifold 198 (e.g., a chamber) of the bearing system 100. The manifold 198 is configured to receive the flow of pressurized fluid 172 from the fluid conduit 132 (e.g., the flexible portion 170) and distribute the pressurized fluid 172 to multiple locations, components, and/or elements of the bearing assembly 196, such as multiple porous elements 126, to enable support and lubrication of the shaft 104. For example, the manifold 198 may define a chamber configured to receive the flow of pressurized fluid 172 and distribute the pressurized fluid 172 to the porous elements 126 via distribution conduits 199 extending from the manifold 198 to corresponding porous elements 126.

Additionally, the bearing assembly 196 includes one or more of the sensors 140, which may be coupled to the porous elements 126, the manifold 198, the feedthrough 136, the fluid conduit 132, the electrical lines 142, and/or any other suitable components of the bearing system 100. The sensors 140 may be configured to detect an operating parameter of the bearing system 100 (e.g., temperature, pressure, contact, position, flow rate, etc.), such as a detection indicative of whether the bearing assembly 196 is in contact (e.g., physical contact) with the shaft 104. As discussed above, the sensors 140 are communicatively connected to the monitoring system 138 (e.g., controller, control system) via the electrical lines 142. The electrical lines 142 extend through the feedthrough connector 136, into the housing 102, and to the sensors 140. In this way, each of the sensors 140 may receive electric current (e.g., power) from a power source external to the housing 102 and/or the sensors 140 may transmit electric current (e.g., sensor data, electrical signals, feedback) from the interior 164 of the housing 102 to the monitoring system 138.

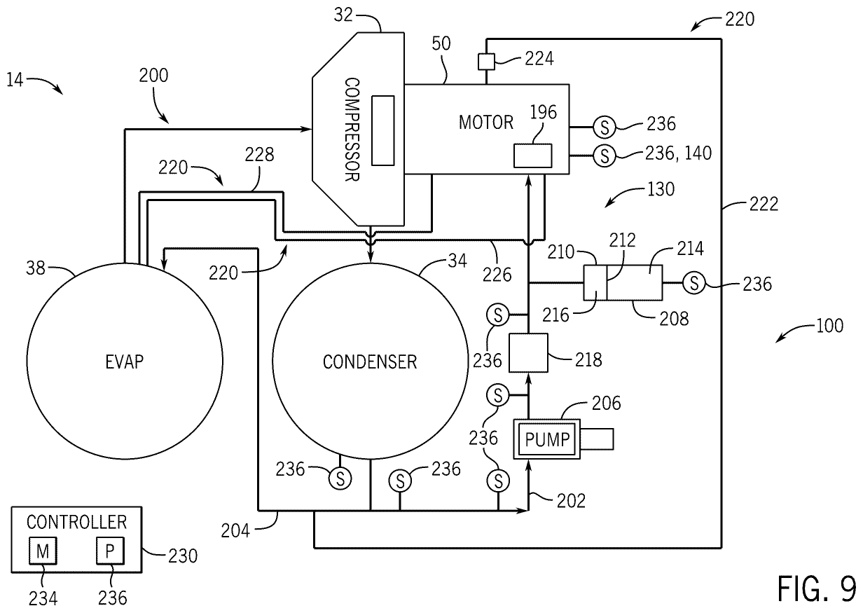

FIG. 9 is a schematic of an embodiment of the vapor compression system 14 (e.g., HVAC&R system) including the bearing system 100 for the compressor 32. The vapor compression system 14 includes elements similar to those discussed above, including the compressor 32, the condenser 34, and the evaporator 38 (e.g., falling film evaporator) arranged along a working fluid circuit 200 (e.g., refrigerant circuit). In accordance with present techniques, the bearing system 100 also includes the fluid supply system 130 configured to direct pressurized fluid to the bearings (e.g., bearing assemblies 196) of the bearing system 100. In particular, the fluid supply system 130 is configured to direct a portion of working fluid (e.g., refrigerant) circulated through the working fluid circuit 200 to the bearing assemblies 196. To this end, the fluid supply system 130 includes a lubricant circuit 202 (e.g., fluid supply circuit) extending from the working fluid circuit 200 to the bearing assemblies 196. The bearing system 100 may also include one or more feedthrough connectors 136 discussed above to enable supply of the pressurized fluid to the bearings of the bearing system 100. Specifically, the feedthrough connectors 136 may be configured to receive pressurized fluid from the lubricant circuit 202 and enable supply of the pressurized fluid to the bearing assemblies 196 within the housing 102 of the compressor 32.

In the illustrated embodiment, the lubricant circuit 202 extends from a liquid line portion 204 of the working fluid circuit 200 to the bearing assemblies 196. The liquid line portion 204 extends from the condenser 34 to the evaporator 38. Thus, working fluid within the liquid line portion 204 may be in a liquid phase. Various components are disposed along the lubricant circuit 202 and are configured to enable desirable supply of working fluid to the bearing assemblies 196 to enable the bearing assemblies 196 to support a load of the shaft 104 of the compressor 32. For example, the fluid supply system 130 includes a pump 206 (e.g., liquid pump) disposed along the lubricant circuit 202 and configured to direct flow of working fluid (e.g. liquid working fluid) along the lubricant circuit 202 from the liquid line portion 204 of the working fluid circuit 200 to the bearing assemblies 196 of the motor 50 (e.g., compressor 32). The pump 206 may be a linear piston pump, in some embodiments, and the pump 206 may be driven electrically, pneumatically, mechanically, electromechanically, and/or via another suitable technique. In some embodiments, the pump 206 may operate without utilizing oil or other dedicated lubricant.

The fluid supply system 130 also includes a pressure accumulator 208 fluidly coupled to the lubricant circuit 202. The pressure accumulator 208 is fluidly coupled to the lubricant circuit 202 downstream of the pump 206 relative to a flow of working fluid along the lubricant circuit 202. Thus, the pressure accumulator 208 may receive a pressurized flow of working fluid (e.g., liquid working fluid, vapor working fluid, or both) from the pump 206 and the lubricant circuit 202. As will be appreciated, the pressure accumulator 208 is configured to store pressurized working fluid therein. For example, the pressure accumulator 208 may include a vessel 210 and a separator 212 (e.g., bladder, diaphragm, piston, etc.) disposed therein. In some embodiments, the separator 212 may divide an internal volume of the vessel 210 into a biasing chamber 214 (e.g., gas chamber) on a first side of the separator 212 and a fluid chamber 216 (e.g., liquid chamber, refrigerant chamber) on a second side the separator 212. The fluid chamber 216 of the pressure accumulator 208 is configured to receive pressurized working fluid from the lubricant circuit 202. The separator 212 may be a bladder or other flexible container pre-charged with a gas (e.g., nitrogen) to enable maintaining the pressure of the working fluid within the fluid chamber 216. In other embodiments, the biasing chamber 214 may be pre-charged with a gas. In still further embodiments, the biasing chamber 214 may instead include a spring or other mechanical biasing component. In any case, the pressure accumulator 208 may operate as a mechanical battery configured to enable supply (e.g., temporary supply) of pressurized working fluid from the fluid chamber 216 to the bearing assemblies 196 via the lubricant circuit 202, such as during periods of non-operation of the pump 206. For example, during an interruption in operation of the pump 206, the pressure accumulator 208 may discharge pressurized working fluid to the lubricant circuit 202 for supply to the bearing assemblies 196. In this way, the bearing assemblies 196 may continue to operate to support a load on the shaft 104 while operation of the pump 206 is restarted and/or while operation of the compressor 32 (e.g., the motor 50) is suspended in a controlled manner. In some embodiments, the pressure accumulator 208 may also operate to damp oscillations in the flow of pressurized working fluid directed to the bearing assemblies 196. Further, the pressure accumulator 208 may be configured to supply pressurized working fluid to the bearing assemblies 196 at startup of the vapor compression system 14 (e.g., prior to operation of the pump 206 and/or the compressor 32).

The fluid supply system 130 may also include other components disposed along the lubricant circuit 202, such as a check valve 218 disposed between the pump 206 and the pressure accumulator 208. The check valve 218 may be configured to close and block flow of liquid working fluid from the pump 206 and along toward the bearing assemblies 196 based on a pressure of the liquid working fluid discharged by the pump 206. For example, in response to a pressure of the liquid working fluid falling below a threshold value (e.g., a threshold value corresponding to a liquid working fluid pressure desired for supply to the bearing assemblies 196), the check valve 218 may close. In such instances, pressurized liquid working fluid stored within the pressure accumulator 208 may be supplied to the bearing assemblies 196 (e.g., with the closed check valve 218 blocking refrigerant flow back to the pump 206) to enable at least temporary continued operation of the bearing assemblies 196 to support the shaft 104.

As mentioned above, the bearing assemblies 196 are configured to receive pressurized working fluid and to discharge the working fluid towards the shaft 104 or collar 128. In particular, the bearing assemblies 196 each include the one or more porous elements 126 configured to direct the pressurized working fluid therethrough and to flash the pressurized working fluid and discharge pressurized vapor working fluid towards the shaft 104 or collar 128. Thereafter, the working fluid may flow through the housing 102 of the compressor 32 (e.g., motor 50) to one or more drain lines 220 of the bearing system 100. For example, the bearing system 100 may include a first drain line 222 extending from the housing 102 to the liquid line portion 204 of the working fluid circuit 200. The first drain line 222 may include a valve 224 (e.g., electronic expansion valve) and/or may be configured to direct vapor working fluid from the housing 102 to the liquid line portion 204 of the working fluid circuit 200. Additionally or alternatively, the bearing system 100 may include a second drain line 226 extending from the housing 102 to the evaporator 38 and/or a third drain line 228 extending from the housing 102 to the evaporator 38. In some embodiments, the second drain line 226 is configured to direct vapor working fluid from the housing 102 to the evaporator 38, and the third drain line 228 is configured to direct liquid working fluid from the housing 102 to the evaporator 38.

The vapor compression system 14 may also include a controller 230 (e.g., a control system, control board, control panel) communicatively coupled to one or more components of the vapor compression system 14 and/or the bearing system 100. The controller 230 is configured to monitor, adjust, and/or otherwise control operation of the components of the vapor compression system 14 and/or the bearing system 100. For example, one or more control transfer devices, such as wires, cables, wireless communication devices, and the like, may communicatively couple the compressor 32, the motor 50, the pump 206, and/or other components described herein. Such components may include a network interface that enables the components of the vapor compression system 14 and/or bearing system 100 to communicate via various protocols such as EtherNet/IP, ControlNet, DeviceNet, or any other communication network protocol. Alternatively, the communication component may enable the components of the vapor compression system 14 and/or bearing system 100 to communicate via mobile telecommunications technology, Bluetooth®, near-field communications technology, and the like.

In some embodiments, the controller 230 may include a portion or all of the control panel 40 or may be another suitable controller included in the vapor compression system 14 and/or the bearing system 100. In some embodiments, the controller 230 may be an embodiment of and/or a component of the monitoring system 138, or the monitoring system 138 may be a component of the controller 230. In any case, the controller 230 may be configured to control components of the vapor compression system 14 and/or the bearing system 100 in accordance with the techniques discussed herein. The controller 230 includes processing circuitry 232, such as one or more microprocessors, which may execute software for controlling the components of the vapor compression system 14 and/or the bearing system 100. The processing circuitry 232 may include multiple microprocessors, one or more “general-purpose” microprocessors, one or more special-purpose microprocessors, and/or one or more application specific integrated circuits (ASICS), or some combination thereof. For example, the processing circuitry 232 may include one or more reduced instruction set (RISC) processors.

The controller 230 may also include a memory device 234 (e.g., a memory) that may store information such as instructions, control software, look up tables, configuration data, etc. The memory device 234 may include a volatile memory, such as random access memory (RAM), and/or a nonvolatile memory, such as read-only memory (ROM). The memory device 234 may store a variety of information and may be used for various purposes. For example, the memory device 234 may store processor-executable instructions including firmware or software for the processing circuitry 232 to execute, such as instructions for controlling components of the vapor compression system 14 and/or the bearing system 100. In some embodiments, the memory device 234 is a tangible, non-transitory, machine-readable-medium that may store machine-readable instructions for the processing circuitry 232 to execute. The memory device 234 may include ROM, flash memory, a hard drive, or any other suitable optical, magnetic, or solid-state storage medium, or a combination thereof. The memory device 234 may store data, instructions, and any other suitable data.

The controller 230 may be configured to control operation of components of the vapor compression system 14 and/or the bearing system 100 based on detected operating parameters of the vapor compression system 14 and/or the bearing system 100. To this end, the vapor compression system 14 includes one or more sensors 236, including the bearing sensors 140, configured to detect operating parameters associated with or indicative of operating conditions of the vapor compression system 14 and the bearing system 100. For example, one or more of the sensors 236 may be disposed along the lubricant circuit 202 and may be configured to detect operating parameters of the working fluid directed through the lubricant circuit 202, such as temperature, pressure, flow rate, and so forth. In some embodiments, one or more sensors 236 may be configured to detect an operating parameter associated with the motor 50, such as a rotational speed of the shaft 104, a torque on the shaft 104, a temperature of the motor 50, and so forth. One or more sensors 236 may be configured to detect an operating parameter of the bearing assemblies 196, such as a detection of whether one or more bearing assemblies 196 is in contact (e.g., physical contact) with the shaft 104. As similarly discussed above, one or more of the sensors 236 disposed within the housing 102 of the compressor 32 may be communicatively coupled to the controller 230 via electrical lines 142 extending through one or more feedthrough connectors 136 secured to the housing 102.

While only certain features and embodiments have been illustrated and described, many modifications and changes may occur to those skilled in the art, such as variations in sizes, dimensions, structures, shapes and proportions of the various elements, values of parameters, such as temperatures and pressures, mounting arrangements, use of materials, colors, orientations, and so forth, without materially departing from the novel teachings and advantages of the subject matter recited in the claims. The order or sequence of any process or method steps may be varied or re-sequenced according to alternative embodiments. It is, therefore, to be understood that the appended claims are intended to cover all such modifications and changes as fall within the true spirit of the disclosure.

Furthermore, in an effort to provide a concise description of the exemplary embodiments, all features of an actual implementation may not have been described, such as those unrelated to the presently contemplated best mode, or those unrelated to enablement. It should be appreciated that in the development of any such actual implementation, as in any engineering or design project, numerous implementation specific decisions may be made. Such a development effort might be complex and time consuming, but would nevertheless be a routine undertaking of design, fabrication, and manufacture for those of ordinary skill having the benefit of this disclosure, without undue experimentation.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(f). However, for any claims containing elements designated in any other manner, it is intended that such elements are not to be interpreted under 35 U.S.C. 112(f).

1. A heating, ventilation, air conditioning, and refrigeration (HVAC&R) system, comprising:
a motor housing of a compressor;
a feedthrough connector coupled to the motor housing, wherein the feedthrough connector comprises a first passage and a second passage formed therethrough, the first passage is configured to receive a fluid conduit, and the second passage is configured to receive an electrical wire;
a bearing disposed within the motor housing, wherein the bearing is configured to receive a pressurized fluid via the fluid conduit; and
a sensor disposed within the motor housing, wherein the electrical wire is configured to transmit electrical signals from the sensor and through the feedthrough connector.

2. The HVAC&R system of claim 1, comprising the fluid conduit and a manifold disposed within the motor housing, wherein the fluid conduit is configured to direct the pressurized fluid to the manifold, and the manifold is configured to direct the pressurized fluid to the bearing.

3. The HVAC&R system of claim 2, wherein the fluid conduit is a first fluid conduit, the HVAC&R system comprises a second fluid conduit fluidly coupled to the first passage of the feedthrough connector, and the second fluid conduit is configured to direct the pressurized fluid to the feedthrough connector.

4. The HVAC&R system of claim 3, wherein the first fluid conduit is formed from a flexible material, and the second fluid conduit is formed from a rigid material.

5. The HVAC&R system of claim 1, wherein the pressurized fluid comprises a working fluid of the HVAC&R system.

6. The HVAC&R system of claim 1, comprising a potting compound disposed within the second passage and configured to hermetically seal the second passage.

7. The HVAC&R system of claim 6, comprising a plurality of electrical wires extending through the second passage, wherein the plurality of electrical wires comprises the electrical wire, each electrical wire of the plurality of electrical wires extends from the feedthrough connector to a corresponding sensor of a plurality of sensors disposed within the motor housing, and the plurality of sensors comprises the sensor.

8. The HVAC&R system of claim 7, wherein the potting compound is configured to electrically isolate the plurality of electrical wires from one another.

9. The HVAC&R system of claim 6, comprising an electrical terminal disposed within the second passage, wherein:
the electrical wire comprises an external segment extending from an exterior environment of the motor housing to the electrical terminal, the electrical wire comprises an internal segment extending from the electrical terminal to the sensor, the electrical terminal is configured to electrically couple the external segment and the internal segment, and the electrical terminal is at least partially encased in the potting compound.

10. The HVAC&R system of claim 1, comprising the fluid conduit and at least one gasket disposed within the first passage and about the fluid conduit, wherein the at least one gasket is configured to block fluid flow through the first passage external to the fluid conduit.

11. A heating, ventilation, air conditioning, and refrigeration (HVAC&R) system, comprising:
a compressor comprising a rotor shaft disposed within a hermetic housing;
a feedthrough connector coupled to the hermetic housing, wherein the feedthrough connector comprises a first passage and a second passage formed therethrough;
a fluid conduit fluidly coupled to the first passage;
an electrical wire extending through the second passage;
a bearing disposed about the rotor shaft, wherein the bearing is configured to receive a pressurized fluid via the fluid conduit; and
a sensor disposed within the hermetic housing, wherein the electrical wire is configured to transmit electrical signals between the sensor and an exterior of the hermetic housing via the feedthrough connector.

12. The HVAC&R system of claim 11, comprising a controller disposed external to the hermetic housing, wherein the electrical wire is configured to transmit the electrical signals from the sensor to the controller, and the sensor comprises a temperature sensor or a position sensor.

13. The HVAC&R system of claim 11, wherein the compressor is configured to circulate a working fluid through a working fluid circuit of the HVAC&R system, the pressurized fluid comprises a portion of the working fluid, and the bearing is configured to discharge the pressurized fluid toward the rotor shaft.

14. The HVAC&R system of claim 11, wherein the feedthrough connector comprises a potting compound disposed within the second passage and configured to hermetically seal the second passage.

15. The HVAC&R system of claim 14, wherein the feedthrough connector comprises an O-ring disposed within the first passage and about the fluid conduit, wherein the O-ring is configured to create a fluidic seal within the first passage external to the fluid conduit.

16. A feedthrough system for a hermetic compressor, comprising:
a feedthrough body comprising a first passage and a second passage formed therethrough;
a fluid conduit fluidly coupled to the first passage and configured to direct a pressurized fluid toward a bearing of the hermetic compressor;
one or more electrical wires extending through the second passage and configured to transmit one or more electric currents through the feedthrough body; and
a potting compound disposed within the second passage and configured to block fluid flow through the second passage.

17. The feedthrough system of claim 16, wherein the feedthrough body is configured to mount to a housing of the hermetic compressor, the one or more electrical wires are configured to electrically couple to one or more sensors disposed within the housing, and the fluid conduit is configured to extend within the housing from the feedthrough body.

18. The feedthrough system of claim 16, wherein the one or more electrical wires comprise a plurality of electrical wires, and the potting compound is configured to electrically isolate the plurality of electrical wires from one another.

19. The feedthrough system of claim 16, comprising at least one O-ring or gasket disposed within the first passage and configured to block fluid flow through the first passage external to the fluid conduit.

20. The feedthrough system of claim 16, comprising an electrical terminal disposed within the second passage, wherein:
an electrical wire of the one or more electrical wires comprises an external segment configured to extend from the feedthrough body and external to the hermetic compressor and an internal segment configured to extend from the feedthrough body and internal to the hermetic compressor,
the electrical terminal is configured to electrically couple the external segment and the internal segment of the electrical wire, and
the electrical terminal is at least partially encased in the potting compound.
